(19) United States
(12) Patent Application Publication
(10) Pub. No.: US 2010/0240824 A1
(43) Pub. Date: Sep. 23, 2010

(54) POWDER COATING SUSPENSIONS (POWDER SLURRIES) AND POWDER COATING MATERIALS, THEIR PREPARATION AND USE

(75) Inventors: Christina Alpert, Munster (DE); Heinz-Peter Rink, Munster (DE); Werner-Alfons Jung, Ascheberg (DE); Elisabeth Wessling, Emsdetten (DE); Markus Oberhoff, Drensteinfurt (DE); Thomas Danner, Ludwigshafen (DE); Andreas Bauder, Mannheim (DE)

Correspondence Address: BASF CORPORATION;Patent Department, 1609 BIDDLE AVENUE, MAIN BUILDING, WYANDOTTE, MI, 48192, US

(73) Assignee: BASF COATINGS AG, Munster (DE)

(21) Appl. No.: 12/160,389

(22) PCT Filed: Jan. 10, 2007
(86) PCT No.: PCT/EP2007/000145

§ 371 Date: Jun. 4, 2010

(30) Foreign Application Priority Data
Jan. 12, 2006 (DE) 10 2006 001 529.0

(51) Int. Cl. C08L 39/04

(52) U.S. Cl. 524/548

(57) ABSTRACT

Disclosed herein is a powder coating suspension prepared in the presence of an emulsifier (A) by emulsifying a liquid component (B) in an aqueous medium (C) to give an aqueous emulsion of liquid particles (D); and cooling the emulsion of liquid particles (D); wherein the emulsifier (A) has a hydroxyl number of 50 to 250 mg KOH/g and is a copolymer prepared by copolymerizing in an aqueous medium (a1) a hydroxyl-containing, olefinically unsaturated monomer; and (a2) an olefinically unsaturated monomer selected from the group consisting of (a21) a monomer of the general formula R¹R²C═CR³R⁴, wherein R¹, R², R³, and R⁴ are independently hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of R¹, R², R³, and R⁴ are aryl, arylalkyl or arylcycloalkyl radicals; (a22) an olefinically unsaturated terpene hydrocarbon; and (a23) a dimeric alpha-alkylvinylaromatic.

### FIELD OF THE INVENTION

The present invention relates to novel powder coating suspensions (powder slurries) and powder coating materials preparable by an emulsification process. The present invention also relates to a process for preparing novel powder coating suspensions (powder slurries) and powder coating materials by emulsification. The present invention additionally relates to the use of the novel powder coating suspensions (powder slurries) and powder coating materials as coating materials, adhesives, and sealing compounds or for producing such compositions, and also to the use of the coating materials, adhesives, and sealing compounds for producing coatings, adhesive layers, and seals.

### PRIOR ART

Powder slurries and powder coating materials preparable by
(1) emulsifying at least one liquid component (B) comprising at least one liquid or liquefied constituent of a powder slurry or powder coating material in an aqueous medium (C) in the presence of an emulsifier whose aqueous solution or dispersion has a surface tension >30 mN/m at the critical micelle concentration (CMC), to give an aqueous emulsion of liquid particles (D),
(2) cooling the emulsion, to form a suspension of dimensionally stable particles (D), i.e., the powder slurry,
   and where the powder coating materials are preparable by
(3) isolating the dimensionally stable particles (D), i.e., the powder coating material,
   are known from German patent application DE 101 26 651 A1. As is known, emulsifiers used are preferably copolymers preparable in an aqueous medium by single-stage or multistage free-radical copolymerization of
   at least one first olefinically unsaturated monomer and
   at least one second olefinically unsaturated monomer, different than the first olefinically unsaturated monomer and of the general formula I

R¹R²C═CR³R⁴ (I),
in which the radicals R¹, R², R³, and R⁴ each independently of one another are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals,
   in an amount of from 0.01 to 5% by weight, based on the amount of the melted or solid particles and of the emulsifiers.

The known powder slurries and powder coating materials can be produced simply, reliably, and reproducibly by the emulsification method, and reliably meet imposed specifications. They yield coatings, especially single-coat or multicoat color and/or effect paint systems, combination effect coats, and clearcoat systems, which have very good optical properties and very high light stability, chemical resistance, water resistance, condensation resistance, and weathering resistance. In particular they are free from turbidities and inhomogeneities. They are hard, flexible, and scratch-resistant. They exhibit very good reflow, outstanding intercoat adhesion, and good to very good adhesion to customary and known automotive refinishes.

Nevertheless, the shear stability of the known powder slurries on ESTA application still leaves something to be desired.

Furthermore, the known powder slurries and powder coating materials sometimes exhibit unsatisfactory leveling, which diminishes their otherwise very good performance properties.

Moreover, there is a need for further improvement in the gloss and haze of the coatings produced from the known powder slurries and powder coating materials, in order to satisfy fully the continually growing demands of the market, particularly of the automakers and their customers.

It would not least be desirable to have available alternatives to the stabilizers, dispersants or emulsifiers of German patent application DE 101 26 651 A1, in order to achieve the aforementioned objects in a particularly advantageous way and to expand the set of instruments for solving technical problems arising in the future with regard to dispersions.

### Problems Addressed by the Invention

Objects of the present invention are in particular to find new powder coating suspensions (powder slurries) and new powder coating materials, preparable by an emulsification method, which can be prepared easily, reliably, and reproducibly and reliably meet imposed specifications. The new powder slurries ought in particular to exhibit high shear stability on ESTA application.

In particular the new powder slurries and powder coating materials ought to yield coatings, especially single-coat or multicoat color and/or effect paint systems, combination effect coats, and clearcoat systems, which exhibit very good optical properties and very high light stability, chemical resistance, water resistance, condensation resistance, and weathering resistance, very good reflow, outstanding intercoat adhesion, and very good adhesion to customary and known automotive refinishes, and are also hard, flexible, and scratch-resistant and free from turbidities and inhomogeneities. At the same time the new coatings ought to be further improved in respect of gloss and haze.

It is an object of the present invention, furthermore, to find a new process for preparing powder coating suspensions (powder slurries) and powder coating materials which simply, reliably, and reproducibly yields on-specification powder slurries and powder coating materials.

It is a further object of the present invention to provide new stabilizers, dispersants or emulsifiers, for processes for preparing powder slurries and powder coating materials by emulsification, that stabilize equally both the initial emulsified liquid particles and the dimensionally stable powder coating particles which result when the emulsion is cooled, and do so to the required extent, and that offer an outstanding alternative to the existing stabilizers, dispersants or emulsifiers.

### Solution Provided by the Invention

Found accordingly have been the novel powder coating suspensions (powder slurries) and powder coating materials preparable in the presence of at least one emulsifier (A), the powder slurries being preparable by
(1) emulsifying at least one liquid component (B) comprising at least one liquid or liquefied constituent of a powder slurry or of a powder coating material in an aqueous medium (C) to give an aqueous emulsion of liquid particles (D),
(2) cooling the emulsion to give a suspension of dimensionally stable particles (D), i.e., the powder slurry,
   and the powder coating materials being preparable by
(3) isolating the dimensionally stable particles (D), i.e., the powder coating material,
   the emulsifier (A) having a hydroxyl number of 50 to 250 mg KOH/g and being selected from the group of copolymers preparable by single-stage or multistage free-radical copolymerization in an aqueous medium of
(a1) at least one hydroxyl-containing, olefinically unsaturated monomer and
(a2) at least one olefinically unsaturated monomer other than the olefinically unsaturated monomer (a1) and selected from the group consisting of
   (a21) monomers of the general formula I

R¹R²C═CR³R⁴ (I),
in which the radicals R¹, R², R³, and R⁴ each independently of one another are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals;
(a22) olefinically unsaturated terpene hydrocarbons; and
(a23) dimeric alpha-alkylvinylaromatics.

The novel powder coating suspensions (powder slurries) and powder coating materials are referred to below as “powder slurries and powder coating materials of the invention”.

Also found has been the novel process for preparing the powder slurries and powder coating materials of the invention in the presence of an emulsifier (A), which comprises
(1) emulsifying at least one liquid component (B) comprising at least one liquid or liquefied constituent of a powder slurry or of a powder coating material in an aqueous medium (C) to give an aqueous emulsion of liquid particles (D), and
(2) cooling the emulsion to give a suspension of dimensionally stable particles (D), i.e., the powder slurry,
   and comprises preparing the powder coating material by
(3) isolating the dimensionally stable particles (D), i.e., the powder coating material.

The novel process for preparing powder coating suspensions (powder slurries) and powder coating materials by melt emulsification is referred to below as “process of the invention”.

Found not least has been the novel use of copolymers (A) having a hydroxyl number of 50 to 250 mg KOH/g, preparable by single-stage or multistage free-radical copolymerization in an aqueous medium of
(a1) at least one olefinically unsaturated monomer and
(a2) at least one olefinically unsaturated monomer other than the olefinically unsaturated monomer (a1) and selected from the group consisting of
   (a21) monomers of the general formula I

R¹R²C═CR³R⁴ (I),
(a22) olefinically unsaturated terpene hydrocarbons, and
(a23) dimeric alpha-alkylvinylaromatics,
   as emulsifiers, this being referred to below as “inventive use”.

Further subject matter of the invention will become apparent from the description.

### ADVANTAGES OF THE INVENTION

In the light of the prior art it was surprising and unforeseeable for the skilled worker that the objects on which the present invention was based could be achieved by means of the inventive use, the process of the invention, and the powder slurries and powder coating materials of the invention.

A particular surprise was that the copolymers (A) in particular had the required properties making them suitable for the process of the invention and for the inventive use. More surprising still was that, particularly in the context of the process of the invention, they offered an outstanding alternative to the existing emulsifiers and stabilized, to the required extent, not only the emulsified liquid particles (D) which formed initially but also the dimensionally stable particles (D) which result after the emulsion has cooled. Consequently they were able considerably to expand and enhance the set of instruments for solving technical problems emerging in the future in the field of emulsifiers, suspensions, and emulsions in general, and the preparation of powder coating suspensions (powder slurries) and powder coating materials in particular.

It was surprising, furthermore, that the powder slurries and powder coating materials of the invention were preparable simply, reliably, and reproducibly, in particular by the process of the invention, reliably met imposed specifications, and had outstanding processing properties. In particular the new powder slurries exhibited high shear stability on ESTA application.

Surprisingly the powder slurries and powder coating materials of the invention gave coatings, especially single-coat or multicoat color and/or effect paint systems, combination effect coats, and clearcoat systems, which exhibited very good optical properties and very high light stability, chemical resistance, water resistance, condensation resistance, and weathering resistance, very good reflow, outstanding intercoat adhesion, and very good adhesion to customary and known automotive refinishes, and which were also hard, flexible, and scratch-resistant, and free from turbidities and inhomogeneities. At the same time the new coatings were further improved in respect of gloss and haze.

### DETAILED DESCRIPTION OF THE INVENTION

In accordance with the invention at least one, especially one, emulsifier (A) is used to prepare the powder slurries and powder coating materials of the invention. The amount of the emulsifier (A) may vary widely and so may be adapted outstandingly to the requirements of the particular case. The emulsifier (A) is used preferably in an amount such that the aqueous emulsions of the particles (D) described in detail below, based in each case on their solids content, contain from 0.01 to 1, preferably from 0.1 to 0.5, and in particular from 0.15 to 0.4% by weight of the emulsifier (A).

Here and below, “solids content” means the sum of the constituents of the aqueous emulsions of the particles (D) that make up the solids of the coatings, adhesive layers, and seals, especially coatings, of the invention that are produced from the powder slurries and powder coating materials of the invention. The predominant fraction of these constituents, i.e., more than 50% by weight, preferably more than 60% by weight, and in particular more than 70% by weight, based in each case on the sum of these constituents, is preferably concentrated in the particles (D). More preferably all constituents concerned are contained within the particles (D).

In accordance with the invention the emulsifiers (A) used are copolymers (A) having a hydroxyl number of 50 to 250 mg KOH/g, selected from the group of copolymers preparable by single-stage or multistage free-radical copolymerization in an aqueous medium of
(a1) at least one hydroxyl-containing, olefinically unsaturated monomer and
(a2) at least one, especially one, olefinically unsaturated monomer other than the olefinically unsaturated monomer (a1) and selected from the group consisting of
   (a21) monomers of the general formula I

R¹R²C═CR³R⁴ (I),
in which the radicals R¹, R², R³, and R⁴ each independently of one another are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals;
(a22) olefinically unsaturated terpene hydrocarbons; and
(a23) dimeric alpha-alkylvinylaromatics.

As monomers (a1) it is possible to use all customary and known, hydroxyl-containing, olefinically unsaturated monomers. Examples of highly suitable monomers (a1) are hydroxyalkyl esters of acrylic acid, methacrylic acid or another alpha,beta-olefinically unsaturated carboxylic acid, which derive from an alkylene glycol esterified with the acid, or which are obtainable by reacting the alpha,beta-olefinically unsaturated carboxylic acid with an alkylene oxide, especially hydroxyalkyl esters of acrylic acid, methacrylic acid, ethacrylic acid, crotonic acid, maleic acid, fumaric acid or itaconic acid in which the hydroxyalkyl group preferably contains up to 20 carbon atoms, such as 2-hydroxyethyl, 2-hydroxypropyl, 3-hydroxypropyl, 3-hydroxybutyl, 4-hydroxybutyl acrylate, methacrylate, ethacrylate, crotonate, maleate, fumarate or itaconate; or hydroxycycloalkyl esters such as 1,4-bis-(hydroxymethyl)cyclohexane, octahydro-4,7-methano-1H-indenedimethanol or methylpropanediol monoacrylate, monomethacrylate, monoethacrylate, monocrotonate, monomaleate, monofumarate or monoitaconate; or reaction products of cyclic esters, such as epsilon-caprolactone, for example, and these hydroxyalkyl or hydroxycycloalkyl esters; or olefinically unsaturated alcohols such as allyl alcohol or polyols such as trimethylolpropane monoallyl or diallyl ether or pentaerythritol monoallyl, diallyl or Many! ether. In general, the monomers (a1) of higher functionality are used in minor amounts, i.e., in amounts which do not lead to crosslinking or gelling of the copolymers (A).

For the preparation of the copolymers (A) the monomers (a1) are used in amounts such that the copolymers (A) have a hydroxyl number of 50 to 250, preferably 80 to 220, and in particular 100 to 200 mg KOH/g.

As monomers (a2) it is possible to use monomers (a21) of the general formula I.

In the general formula I the radicals R¹, R², R³, and R⁴ each independently of one another are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³ and R⁴ are substituted or unsubstituted aryl, arylalkyl or arylcycloalkyl radicals, especially substituted or unsubstituted aryl radicals.

Examples of suitable alkyl radicals are methyl, ethyl, propyl, isopropyl, n-butyl, isobutyl, tert-butyl, amyl, hexyl or 2-ethylhexyl.

Examples of suitable cycloalkyl radicals are cyclobutyl, cyclopentyl or cyclohexyl.

Examples of suitable alkylcycloalkyl radicals are methylenecyclohexane, ethylenecyclohexane or propane-1,3-diylcyclohexane.

Examples of suitable cycloalkylalkyl radicals are 2-, 3- or 4-methyl-, -ethyl-, -propyl- or -butylcyclohex-1-yl.

Examples of suitable aryl radicals are phenyl, naphthyl or biphenylyl.

Examples of suitable alkylaryl radicals are benzyl or ethylene- or propane-1,3-diylbenzene.

Examples of suitable cycloalkylaryl radicals are 2-, 3- or 4-phenylcyclohex-1-yl.

Examples of suitable arylalkyl radicals are 2-, 3- or 4-methyl-, -ethyl-, -propyl- or -butylphen-1-yl.

Examples of suitable arylcycloalkyl radicals are 2-, 3- or 4-cyclohexylphen-1-yl.

The above-described radicals R¹, R², R³, and R⁴ may be substituted. The substituents used may comprise electron-withdrawing or electron-donating atoms or organic radicals.

Examples of suitable substituents are halogen atoms, especially chlorine and fluorine, nitrile groups, nitro groups, partially or fully halogenated, especially chlorinated and/or fluorinated, alkyl, cycloalkyl, alkylcycloalkyl, cycloalkylalkyl, aryl, alkylaryl, cycloalkylaryl, arylalkyl and arylcycloalkyl radicals, including those exemplified above, especially tert-butyl; aryloxy, alkyloxy and cycloalkyloxy radicals, especially phenoxy, naphthoxy, methoxy, ethoxy, propoxy, butyloxy or cyclohexyloxy; arylthio, alkylthio and cycloalkylthio radicals, especially phenylthio, naphthylthio, methylthio, ethylthio, propylthio, butylthio or cyclohexylthio; hydroxyl groups; and/or primary, secondary and/or tertiary amino groups, especially amino, N-methylamino, N-ethylamino, N-propylamino, N-phenylamino, N-cyclohexylamino, N,N-di-methylamino, N,N-diethylamino, N,N-dipropylamino, N,N-diphenylamino, N,N-dicyclohexylamino, N-cyclohexyl-N-methylamino and N-ethyl-N-methylamino.

Examples of monomers (a121) whose use is particularly preferred in accordance with the invention are diphenylethylene, dinaphthaleneethylene, cis- or trans-stilbene, vinylidenebis(4-N,N-dimethylaminobenzene), vinylidenebis(4-aminobenzene), and vinylidenebis(4-nitrobenzene).

The monomers (a21) may be used individually or as a mixture of at least two monomers (a21).

In terms of the reaction regime and the properties of the resultant copolymers (A), especially the acrylate copolymers (A), diphenylethylene (a21) is of very particular advantage and is therefore used with very particular preference as monomer (a21) of the general formula I.

As monomers (a2) it is additionally possible to use olefinically unsaturated terpene hydrocarbons (a22).

The olefinically unsaturated terpene hydrocarbons (a22) are customary and known, naturally occurring or synthetic compounds. It is preferred to use olefinically unsaturated terpene hydrocarbons containing no reactive functional groups, such as hydroxyl groups, amino groups or carbonyl groups.

The olefinically unsaturated terpene hydrocarbon (a22) is selected preferably from the group consisting of acyclic diterpenes, monocyclic terpenes, bicyclic terpenes, acyclic sesquiterpenes, monocyclic sesquiterpenes, bicyclic sesquiterpenes, tricyclic sesquiterpenes, acyclic diterpenes, monocyclic diterpenes, and tricyclic diterpenes.

More preferably the terpene hydrocarbon (a22) is selected from the group consisting of acyclic monoterpenes, monocyclic terpenes, and bicyclic terpenes.

With very particular preference the terpene hydrocarbon (a22) is selected from the group consisting of ocimene, myrcene, the menthenes, the menthadienes, alpha-pinene, and beta-pinene.

The menthadienes (a22) are selected in particular from the group consisting of alpha-terpinene, beta-terpinene, gamma-terpinene, terpinolene, alpha-phellandrene, beta-phellandrene, limonene, and dipentene.

gamma-Terpinene is used especially as monomer (a22).

As monomers (a2) it is possible not least to use dimeric alpha-alkylvinylaromatics (a23) and preferably dimeric alpha-alkylstyrenes (a23), especially dimeric alpha-methylstyrene (a23).

The above-described olefinically unsaturated monomers (a1) and (a2) can additionally be copolymerized with at least one different olefinically unsaturated monomer (a3).

Examples of suitable monomers (a3) are
(a31) substantially acid-group-free (meth)acrylic esters such as (meth)acrylic alkyl or cycloalkyl esters having up to 20 carbon atoms in the alkyl radical, especially methyl, ethyl, propyl, n-butyl, sec-butyl, tert-butyl, hexyl, ethylhexyl, stearyl and lauryl acrylate or methacrylate; cycloaliphatic (meth)acrylic esters, especially cyclohexyl, isobornyl, dicyclopentadienyl, octahydro-4,7-methano-1H-indenemethanol or tert-butyl-cyclohexyl (meth)acrylate; (meth)acrylic oxaalkyl esters or oxacycloalkyl esters such as ethyltriglycol (meth)acrylate and methoxyoligoglycol (meth)acrylate having a molecular weight Mn of preferably 550, or other ethoxylated and/or propoxylated hydroxyl-free (meth)acrylic acid derivatives. These may contain minor amounts of (meth)acrylic alkyl or cycloalkyl esters of higher functionality, such as the di(meth)acrylates of ethylene glycol, propylene glycol, diethylene glycol, dipropylene glycol, butylene glycol, 1,5-pentanediol, 1,6-hexanediol, octahydro-4,7-methano-1H-indenedimethanol or 1,2-, 1,3- or 1,4-cyclohexanediol; trimethylolpropane di- or tri-(meth)acrylate; or pentaerythritol di-, tri- or tetra(meth)acrylate. By minor amounts of monomers of higher functionality are meant as amounts which do not lead to crosslinking or gelling of the copolymers (A).
(a32) Monomers which carry per molecule at least one amino group, alkoxymethylamino group or imino group and are substantially free from acid groups, such as N,N-dimethylaminoethyl acrylate, N,N-diethylaminoethyl methacrylate, allylamine or N-methyliminomethyl acrylate or N,N-di(methoxymethyl)aminoethyl acrylate and methacrylate or N,N-di(butoxymethyl)aminopropyl acrylate and methacrylate.
(a33) Monomers which carry per molecule at least one acid group which can be converted to the corresponding acid anion group, such as acrylic acid, beta-carboxyethyl acrylate, methacrylic acid, ethacrylic acid, crotonic acid, maleic acid, fumaric acid or itaconic acid; olefinically unsaturated sulfonic or phosphonic acids or their partial esters; or mono(meth)acryloyloxyethyl maleate, succinate or phthalate.
(a34) Vinyl esters of alpha-branched monocarboxylic acids having 5 to 18 carbon atoms in the molecule. The branched monocarboxylic acids can be obtained by reacting formic acid or carbon monoxide and water with olefins in the presence of a liquid, strongly acidic catalyst; the olefins may be cracking products of paraffinic hydrocarbons, such as mineral oil fractions, and may comprise both branched and straight-chain acyclic and/or cycloaliphatic olefins. The reaction of such olefins with formic acid or, respectively, with carbon monoxide and water produces a mixture of carboxylic acids in which the carboxyl groups are located predominantly on a quaternary carbon atom. Examples of other olefinic starting materials are propylene trimer, propylene tetramer and diisobutylene. Alternatively, the vinyl esters (a34) may be prepared in a conventional manner from the acids, by reacting, for example, the acid with acetylene. Particular preference, owing to their ready availability, is given to using vinyl esters of saturated aliphatic monocarboxylic acids having 9 to 11 carbon atoms that are branched on the alpha carbon atom, but especially Versatic® acids.
(a35) Reaction products of acrylic acid and/or methacrylic acid with the glycidyl ester of an alpha-branched monocarboxylic acid having 5 to 18 carbon atoms per molecule, especially a Versatic® acid, or, instead of the reaction product, an equivalent amount of acrylic acid and/or methacrylic acid which is then reacted during or after the polymerization reaction with the glycidyl ester of an alpha-branched monocarboxylic acid having 5 to 18 carbon atoms per molecule, especially a Versatic® acid.
(a36) Cyclic and/or acyclic olefins such as ethylene, propylene, 1-butene, 1-pentene, 1-hexene, cyclohexene, cyclopentene, norbornene, butadiene, isoprene, cyclopentadiene and/or dicyclopentadiene.
(a37) (Meth)acrylamides such as (meth)acrylamide, N-methyl-, N,N-dimethyl-, N-ethyl-, N,N-diethyl-, N-propyl-, N,N-dipropyl-, N-butyl-, N,N-dibutyl-, N-cyclohexyl-, N,N-cyclohexyl methyl- and/or N-methylol-, N,N-dimethylol-, N-methoxymethyl-, N,N-di(methoxymethyl)-, N-ethoxymethyl- and/or N,N-di(ethoxyethyl)(meth)acrylamide. Monomers of the last-mentioned kind are used in particular to prepare self-crosslinking binders.
(a38) Monomers containing epoxide groups, such as the glycidyl ester of acrylic acid, methacrylic acid, ethacrylic acid, crotonic acid, maleic acid, fumaric acid and/or itaconic acid.
(a39) Vinylaromatic hydrocarbons such as styrene, alpha-alkylstyrenes, especially alpha-methylstyrene, and/or vinyltoluene; vinylbenzoic acid (all isomers), N,N-diethylaminostyrene (all isomers), alpha-methylvinylbenzoic acid (all isomers), N,N-diethylamino-alpha-methylstyrene (all isomers) and/or p-vinylbenzenesulfonic acid.
(a310) Nitriles such as acrylonitrile and/or methacrylonitrile.
(a311) Vinyl compounds, especially vinyl halides and/or vinylidene dihalides such as vinyl chloride, vinyl fluoride, vinylidene dichloride or vinylidene difluoride; N-vinylamides such as vinyl-N-methylformamide, N-vinylcaprolactam, 1-vinylimidazole or N-vinylpyrrolidone; vinyl ethers such as ethyl vinyl ether, n-propyl vinyl ether, isopropyl vinyl ether, n-butyl vinyl ether, isobutyl vinyl ether and/or vinyl cyclohexyl ether; and/or vinyl esters such as vinyl acetate, vinyl propionate, vinyl butyrate, vinyl pivalate and/or the vinyl ester of 2-methyl-2-ethylheptanoic acid.
(a312) Allyl compounds, especially allyl ethers and allyl esters such as allyl methyl, ethyl, propyl or butyl ether or allyl acetate, propionate or butyrate.
(a313) Polysiloxane macromonomers having a number-average molecular weight Mn of from 1000 to 40 000 and having on average from 0.5 to 2.5 ethylenically unsaturated double bonds per molecule; especially polysiloxane macromonomers having a number-average molecular weight Mn of from 2000 to 20 000, with particular preference from 2500 to 10 000 and, in particular, from 3000 to 7000 and having on average from 0.5 to 2.5, preferably from 0.5 to 1.5, ethylenically unsaturated double bonds per molecule, as are described in DE 38 07 571 A1 on pages 5 to 7, in DE 37 06 095 A1 in columns 3 to 7, in EP 0 358 153 B1 on pages 3 to 6, in U.S. Pat. No. 4,754,014 in columns 5 to 9, in DE 44 21 823 A1 or in the international patent application WO 92/22615 on page 12 line 18 to page 18 line 10.
   and/or
(a314) Acryloyloxysilane-containing vinyl monomers, preparable by reacting hydroxy-functional silanes with epichlorohydrin and then reacting the reaction product with (meth)acrylic acid and/or with hydroxyalkyl and/or hydroxycycloalkyl esters of (meth)acrylic acid (cf. monomers a112).

Each of the abovementioned monomers (a31) to (a314) may be polymerized on their own with the monomers (a1) and (a2). In accordance with the invention, however, it is advantageous to use at least two monomers (a3), since by this means it is possible to vary the profile of properties of the resulting copolymers (A) very widely, in a particularly advantageous manner, and to tailor said profile of properties to the particular process of the invention. In particular, it is possible in this way to incorporate into the copolymers (A) further reactive functional groups by means of which the copolymers (A) may be incorporated by crosslinking into the coatings, adhesive layers, and seals produced from the powder slurries and powder coating materials of the invention.

It is preferred to use monomers (a33) as monomers (a3). Their amounts may be varied widely and adapted outstandingly to the requirements of the particular case. With particular preference they are used in amounts such as to give copolymers (A) having an acid number of 100 to 400, very preferably 100 to 350, and in particular 100 to 300 mg KOH/g.

The monomers (a1) and (a2) and also, if desired, (a3) are reacted with one another in the presence of at least one free-radical initiator to form the copolymer (A). Examples of initiators which can be used are: dialkyl peroxides, such as di-tert-butyl peroxide or dicumyl peroxide; hydroperoxides, such as cumene hydroperoxide or tert-butyl hydroperoxide; peresters, such as tert-butyl perbenzoate, tert-butyl perpivalate, tert-butyl per-3,5,5-trimethylhexanoate or tert-butyl per-2-ethylhexanoate; potassium, sodium or ammonium peroxodisulfate; azo dinitriles such as azobisisobutyronitrile; C—C-cleaving initiators such as benzpinacol silyl ethers; or a combination of a nonoxidizing initiator with hydrogen peroxide.

It is preferred to add comparatively large amounts of free-radical initiator, the proportion of the initiator in the reaction mixture being, based in each case on the overall amount of the monomers (a1) and (a2) and also, if desired, (a3) and of the initiator, with preference from 0.5 to 50% by weight, with particular preference from 1 to 20% by weight, and in particular from 2 to 15% by weight.

Preferably, the weight ratio of initiator to the monomers (a2) is from 4:1 to 1:4, with particular preference from 3:1 to 1:3, and in particular from 2:1 to 1:2. Further advantages result if the initiator is used in excess within the stated limits.

The free-radical copolymerization is preferably conducted in conventional known apparatus, especially stirred tanks, tube reactors or Taylor reactors, the Taylor reactors being designed such that the conditions of Taylor flow are met over the entire reactor length, even if the kinematic viscosity of the reaction medium alters greatly, and in particular increases, owing to the copolymerization.

The copolymerization is conducted in an aqueous medium.

The aqueous medium substantially comprises water. The aqueous medium may include minor amounts of the below-detailed additives and/or organic solvents and/or other dissolved solid, liquid or gaseous organic and/or inorganic substances of low and/or high molecular mass, provided these do not adversely affect, or even inhibit, the copolymerization. In the context of the present invention, a “minor amount” is to be understood as an amount which does not remove the aqueous character of the aqueous medium. Alternatively, the aqueous medium may comprise water alone.

The copolymerization is preferably conducted in the presence of at least one base. Particular preference is given to low molecular mass bases such as sodium hydroxide solution, potassium hydroxide solution, ammonia, diethanolamine, triethanolamine, mono-, di- and triethylamine, and/or dimethylethanolamine, especially ammonia and/or di- and/or triethanolamine.

The copolymerization is advantageously conducted at temperatures above room temperature and below the lowest decomposition temperature of the monomers (a1) and (a2) and also, if desired, (a3) used in each case, preference being given to a chosen temperature range of from 10 to 150° C., with very particular preference from 70 to 120° C., and in particular from 80 to 110° C.

When using particularly volatile monomers (a1) and (a2) and also, if desired, (a3) the copolymerization may also be conducted under pressure, preferably under from 1.5 to 3000 bar, with particular preference from 5 to 1500 bar, and in particular from 10 to 1000 bar.

In terms of the molecular weight distribution, there are no restrictions whatsoever imposed on the copolymer (A). Advantageously, however, the copolymerization is conducted so as to give a molecular weight distribution Mw/Mn, measured by gel permeation chromatography using polystyrene as standard, of ≦4, with particular preference ≦2, and in particular ≦1.5, and in certain cases even ≦1.3. The molecular weights of the copolymers (A) may be controlled within wide limits by the choice of the ratio of monomer (a1) and (a2) and also, if desired, (a3) to free-radical initiator. In this context, the amount of monomer (a2) in particular determines the molecular weight, specifically such that the higher the proportion of monomer (a2), the lower the resultant molecular weight.

The copolymer (A) resulting from the copolymerization is obtained as a mixture with the aqueous medium, generally in the form of a dispersion (A). In this form it can be used as an emulsifier (A) directly or else isolated as a solid (A) and then passed on to the process of the invention and to the inventive use.

In the process of the invention the emulsifier (A) is introduced preferably via the aqueous media (C) into the aqueous emulsions of liquid particles (D) and ultimately into the suspensions of dimensionally stable particles (D).

In one embodiment of the process of the invention, which is employed for the preparation of pigmented powder slurries and powder coating materials of the invention, the emulsifier (A) is introduced via at least one pigment paste or pigment preparation into the aqueous media (C). Or else the pigment pastes or pigment preparations in question form the aqueous media (C).

The amount of emulsifier (A) for inventive use in the aqueous media (C) may vary widely and is guided by the requirements of the particular case, in particular by the solids content of the emulsions of the liquid particles (D). The aqueous medium (C), based in each case on (C), contains the emulsifier (A) in an amount preferably of 0.01 to 5 and in particular of 0.1 to 2.5% by weight and the thickener (a2) in an amount of 0.02 to 10 and in particular 0.1 to 5% by weight.

In the process of the invention it is possible to use not only the emulsifier (A) for inventive use but also at least one, especially one, thickener (E). It is, however, a particular advantage of the process of the invention and of the inventive use that the powder slurries and powder coating materials of the invention can be prepared even without the use of a thickener (E).

Where it is used, the thickener (E) is employed preferably in an amount of 0.01 to 2, preferably 0.1 to 1, and in particular 0.3 to 0.8% by weight, based in each case on the solids content of the below-described aqueous emulsions of the particles (D).

Preference is given to using thickeners (E) based on at least one acid-functional (meth)acrylate (co)polymer (E), in particular a (meth)acrylate copolymer (E). The term “(meth)acrylate” here is to be interpreted in the customary and known way, as a short form for “acrylate and/or methacrylate”.

The acid groups are selected preferably from the group consisting of carboxyl groups, sulfonic acid groups, phosphonic acid groups, phosphate ester groups, and sulfuric ester groups, especially carboxyl groups.

The (meth)acrylate (co)polymers (E) are selected preferably from the group consisting of homopolymers (E1) of acrylic acid or of methacrylic acid, copolymers (E2) of acrylic acid with methacrylic acid, and copolymers (E3) of (meth)acrylic acid with at least one further, different olefinically unsaturated monomer.

Preference is given to using the copolymers (E3).

The copolymers (E3) are selected with particular preference from the group consisting of methacrylate copolymers (E3) based on (C₁-C₆)-alkyl (meth)acrylate and (meth)acrylic acid.

The methacrylate copolymers (E3) are used in particular in the form of an acidic emulsion of low viscosity, as described for example in German patent application DE 100 43 405 C1, column 11, para. [0075]. The emulsions (E3) are commercial products and are sold for example by Ciba Specialty Chemicals under the brand name Viscalex® HV30 or L030.

The starting materials used in the process of the invention, i.e., the constituents of the powder slurries or powder coating materials of the invention, are selected with a view to the desired composition and curing mechanism of the powder slurries and powder coating materials of the invention.

The powder slurries and powder coating materials of the invention may be physically curing.

In the context of the present invention the term “physical curing” denotes the curing of a layer of particles of the powder slurry or the powder coating material of the invention by filming, with linking within the coating taking place by looping of the polymer molecules of the binders (regarding the term cf. Römpp Lexikon Lacke und Druckfarben, Georg Thieme Verlag, Stuttgart, New York, 1998, “binders”, pages 73 and 74). Or else filming takes place by way of the coalescence of binder particles (cf. Römpp Lexikon Lacke und Druckfarben, Georg Thieme Verlag, Stuttgart, New York, 1998, “curing”, pages 274 and 275). Normally, no crosslinking agents are required for this purpose. If desired, physical curing may be assisted by atmospheric oxygen, by heat, or by exposure to actinic radiation.

The powder slurries and powder coating materials of the invention may be thermally curable. In this case they may be self-crosslinking or externally crosslinking.

In the context of the present invention the term “self-crosslinking” denotes the capacity of a binder to enter into crosslinking reactions with itself. A prerequisite for this is that the binders already contain both kinds of complementary reactive functional groups which are necessary for crosslinking. Externally crosslinking, on the other hand, is a term used to refer to those coating materials in which one kind of the complementary reactive functional groups is present in the binder and the other kind is present in a curing agent or crosslinking agent. For further details, refer to Römpp Lexikon Lacke und Druckfarben, Georg Thieme Verlag, Stuttgart, New York, 1998, “curing”, pages 274 to 276, especially bottom page 275.

The powder slurries and powder coating materials of the invention may be curable with actinic radiation.

In this case curing takes place by way of groups containing bonds which can be activated with actinic radiation. In the context of the present invention, actinic radiation means electromagnetic radiation, such as near infrared (NIR), visible light, UV radiation, X-rays or gamma rays, especially UV radiation, and particulate radiation such as electron beams, proton beams, neutron beams, alpha radiation or beta radiation, especially electron beams.

The powder slurries and powder coating materials of the invention may be curable thermally and with actinic radiation.

Where thermal curing and curing with actinic light are employed together for one powder slurry or one powder coating material, the terms “dual cure” and “dual-cure powder coating material” and “dual-cure powder slurry” are also used.

The powder slurries and powder coating materials of the invention are preferably one-component (1K) systems.

In the context of the present invention, one-component (1K) systems are powder slurries and powder coating materials which cure thermally or both thermally and with actinic radiation and in which the binder and the crosslinking agent are present alongside one another in the suspended particles. A prerequisite for this is that the two constituents crosslink with one another only at relatively high temperatures and/or on exposure to actinic radiation.

The amount of dimensionally stable particles (D) in the powder slurries of the invention may vary very widely and is guided by the requirements of each individual case. It is preferably from 5.0 to 60, more preferably from 10 to 55, with particular preference from 15 to 50, with very particular preference from 20 to 50, and in particular from 25 to 50% by weight, based in each case on the total amount of the powder slurry of the invention.

Similarly, the average particle size of the dimensionally stable particles (D) of the powder slurries of the invention may vary widely. It is preferably between 0.1 and 100, more preferably between 0.2 and 80, with particular preference between 0.3 and 60, with very particular preference between 0.4 and 40, and in particular from 0.5 to 20 μm. For especially demanding end uses such as automotive OEM finishing, particle sizes of from 1 to 10 μm are especially advantageous. The average particle size is preferably determined by the laser diffraction method. In the case of an average particle size <1 μm preference is given to employing photo correlation spectroscopy.

The size of the dimensionally stable particles (D) of the powder coating materials of the invention may likewise vary widely. It is preferably between 5 and 500, more preferably between 5 and 400, with particular preference between 5 and 300, with very particular preference between 10 and 200, and in particular between 10 and 100 μm. The average particle size is preferably from 10 to 300, more preferably from 10 to 200, with particular preference from 10 to 150, with very particular preference from 10 to 100, and in particular from 10 to 50 μm. The particle size distribution may be narrow or broad. In the majority of cases a narrow particle size distribution, as described in the patent applications and literature references EP 0 687 714 A1, DE 42 04 266 A1, DE 40 38 681 A1, P. G. de Lange and P. Selier, “Korngröβenverteilung und Eigenschaften von elektrostatischen Spritzpulvern (1)—Fraktionierung des Pulvers und Charakterisierung der Fraktionen” [Particle size distribution and properties of electrostatic spray powders (1)—fractionation of the powder and characterization of the fractions], Farbe und Lack, vol. 79, no. 5, 1973, pages 403 to 412, P. G. de Lange and P. Selier, “Korngröβenverteilung und Eigenschaften von elektrostatischen Spritzpulvern (2)—Verhalten der Pulverfraktionen beim Spritzen und nach dem Einbrennen” [Particle size distribution and properties of electrostatic spray powders (2)—powder fraction behavior during spraying and after baking], Farbe und Lack, vol. 79, no. 6, 1973, pages 509 to 517, and EP 0 536 791 A1, is of advantage. Here too, the average particle size is preferably determined by the laser diffraction method.

In the context of the present invention, “dimensionally stable” means that under the customary and known conditions of the storage and application of powder coating materials or powder coating suspensions the particles (D) undergo little if any agglomeration and/or break down into smaller particles but instead substantially retain their original form even under the influence of shear forces. The particles (D) may be highly viscous and/or solid. Preferably, the dimensionally stable particles (D) are solid.

The powder slurries and powder coating materials of the invention are preferably free from volatile organic compounds (VOCs), especially from organic solvents (cosolvents). In the context of the present invention this means that they have a residual VOC content of <1% by weight, preferably <0.5% by weight, and with particular preference <0.2% by weight. In accordance with the invention it is of very particular advantage if the residual content is situated below the gas-chromatographic detection limit.

The process of the invention starts with the preparation of at least one liquid component (B) comprising at least one liquid starting product and/or at least one liquid or liquefied constituent of the powder slurries and powder coating materials of the invention. The constituent may already be liquid at room temperature or may only melt at higher temperatures. The essential factor is that the starting product is liquid at the process temperatures employed. Preferably, the constituent is solid at room temperature. In particular, this starting product comprises at least one binder.

The preparation of the liquid components (B) has no special features in terms of its method but instead takes place using the customary and known techniques and apparatus for preparing melts, especially polymer melts, such as extruders, stirred tanks, Taylor reactors, tube reactors, loop reactors, etc.

The process temperatures are chosen so as not to exceed the decomposition temperature of the starting product or constituent which decomposes the most readily. Preference is given to employing process temperatures of from 50 to 250, preferably from 60 to 220, with particular preference from 70 to 200, with very particular preference from 80 to 190, and in particular from 90 to 180° C.

In the process of the invention, the liquid component(s) (B) is or are then supplied to suitable mixing units, in which they are emulsified in an aqueous medium (C). The aqueous medium (C) preferably includes the emulsifier (A) described above for inventive use.

In another variant of the process of the invention, at least two liquid components (B), each comprising at least one liquid starting product and/or at least one liquid or liquefied constituent, are first supplied to a customary and known static mixer, and homogenized. Examples of suitable mixers are those of Sulzer type, sold by Sulzer Chemtech GmbH. The combined melts (B) are then supplied to the mixing unit.

Preferably, the liquid components (B) each have such high process temperatures that during the mixing operation one liquid component (B) is not cooled by the other to such an extent that solid agglomerates are formed. On the other hand, the process temperatures of the liquid components (B) must not be chosen to be so high that one liquid component (B) is heated by the other to such an extent that, say, decomposition reactions occur. With particular preference, the liquid components (B) have the same or approximately the same process temperature during the mixing operation.

Mixing units which are suitable for emulsifying liquid components (B) in the aqueous media (C) are customary and known. Examples of suitable mixing units are inline dissolvers having a rotor/stator construction, preferably toothed-ring dispersing units particularly comprising at least one cylindrical arrangement of at least two comminutor rings (stator and rotor) which are seated on holders, are in mutual embrace, and are rotatable in opposite directions relative to one another, the working gap which results from the relative movement between stator and rotor having walls which extend nonparallelwise with respect to one another. In this case it is of advantage if the rotor rotates in the sense of an opening working gap. Examples of highly suitable toothed-ring dispersing units are described in detail in the patent EP 0 648 537 A1. They are sold under the trade name “K-Generatoren” by Kinematica AG, Lucerne, Switzerland.

It is a particular advantage of the process of the invention that the emulsification can be carried out at comparatively low temperatures. It is carried out preferably at temperatures from 100 to 200, more preferably from 100 to 160, and in particular from 100 to 130° C.

Following emulsification, the resultant emulsified liquid particles (D) are cooled, thereby giving the suspended, dimensionally stable particles (D).

For the preparation of the powder slurries of the invention it is preferred to melt at least one binder and to supply it in the liquid state to a toothed-ring dispersing unit, in which it is emulsified in the aqueous medium (C).

The temperature of the melt(s) (B) may vary very widely and is guided by the material composition of the binders. In general, temperatures are employed at which the binders are not thermally damaged. It is preferred to employ temperatures of from 110 to 200, more preferably from 115 to 180, and in particular from 120 to 160° C. In this context it should be ensured that in the course of the process of the invention the binder melts (B) are cooled down again as rapidly as possible, in order to minimize the risk of thermal damage. The skilled worker will therefore be able to determine the temperature/time window that is suitable for the respective case in a simple manner on the basis of his or her general knowledge in the art, with or without the assistance of rangefinding tests.

If additionally at least one crosslinking agent and/or at least one additive is employed to prepare the powder slurries of the invention, all of the starting products or constituents are liquefied or melted separately from one another and supplied to the toothed-ring dispersing unit, in which they are emulsified in the aqueous medium (C). Unmeltable constituents like the below-described pigments, for example, are used in liquefied, suspension form.

As regards the temperature/time window employed in this case, the comment made above applies mutatis mutandis, with the further consideration that it is necessary to prevent the premature reaction of the binders with the crosslinking agents.

The emulsion is cooled rapidly following dispersion so that a suspension is formed. In this context it is preferred to employ the methods described in DE 196 52 813 A1, column 8 lines 9 to 17.

As a result of cooling, the liquid particles (D) become dimensionally stable, thereby giving a suspension. If desired, the suspension or the powder slurry of the invention is wet-ground additionally in an appropriate means, such as a stirred mill or laboratory mill, and is filtered prior to its application. The customary and known filtration apparatus and filters, as also suitable for filtering known powder slurries, are used for this purpose. The mesh size of the filters may vary widely and is guided primarily by the particle size and by the particle size distribution of the particles (D) of the suspension. The skilled worker will therefore easily be able to determine the appropriate filters on the basis of this physical parameter. Examples of suitable filters are bag filters. These are available commercially under the brand names Pong® or Cuno®. It is preferred to use bag filters having mesh sizes of from 10 to 50 μm, examples being Pong® 10 to Pong® 50.

To prepare the powder coating materials of the invention, the suspended dimensionally stable particles (D) are isolated. Viewed in terms of its method, the isolation has no special features but instead takes place by means of the customary and known apparatus and techniques, as employed, for example, in filtration, spray drying, or freeze drying. Highly suitable drying techniques are those using rotary atomizers, pressure atomizers or pneumatic atomizers, as described in the international patent application WO 99/01499, page 5 line 24 to page 7 line 27, and page 27 line 16 to page 28 line 19.

When preparing powder slurries and powder coating materials of the invention which can be crosslinked with actinic radiation, it is of advantage to work in the absence of actinic radiation.

The emulsified liquid particles and the suspended dimensionally stable particles (D) comprise or consist of at least one binder.

Examples of suitable binders and the amounts in which they are employed are known from German patent application DE 101 26 651 A1, page 9, para. [0089] to page 14, para. [0127].

The externally crosslinking powder coating materials and powder slurries of the invention that are curable thermally or both thermally and with actinic radiation, and/or the particles (D) used to prepare them, comprise at least one crosslinking agent that contains the reactive functional groups that are complementary to the reactive functional groups of the binders. The skilled worker is therefore able easily to select the crosslinking agents that are suitable for the particular case.

Examples of suitable crosslinking agents and the amounts in which they are employed are likewise known from German patent application DE 101 26 651 A1, page 14, paras. [0129] and [0130].

Depending on the intended use of the powder slurries and powder coating materials of the invention, they may comprise color and/or effect pigments, fluorescent pigments, electrically conductive pigments and/or magnetically shielding pigments, metal powders, organic and inorganic, transparent or opaque fillers and/or nanoparticles (“pigments” collectively below).

The pigments are used when the powder slurries and powder coating materials of the invention are intended for use as pigmented coating materials, adhesives, and sealing compounds. In the process of the invention they are preferably dispersed in the form of pigment pastes or pigment preparations (cf. Römpp Lexikon Lacke and Druckfarben, Georg Thieme Verlag, Stuttgart, New York, 1998, “pigment preparations”, page 452) into the aqueous media (C) or, as already mentioned above, the pigment pastes or pigment preparations form the aqueous media (C). Preferably, they comprise the mixtures (A) for inventive use described above.

In one embodiment of the process of the invention, the emulsified or suspended particles (D) comprise at least one pigment; i.e., the total amount of the pigments used is present in and/or on the particles (D).

In another embodiment of the process of the invention, the emulsified or suspended particles (D) contain no pigment; i.e., all of the pigments are present in the form of a separate solid phase. Regarding their particle size, the comments made above apply analogously.

In yet another embodiment of the process of the invention, the emulsified or suspended particles (D) comprise, in the sense set out above, a portion of the pigments used, while the other portion of the pigments is present in the form of a separate solid phase. In this case, the fraction present in the particles (D) may comprise the majority, i.e., more than 50%, of the pigments used. It is, however, also possible for less than 50% to be present in and/or on the particles (D). Regarding the particle sizes, the comments made above apply analogously here as well.

Which variant of the process of the invention is given preference in preparing the pigmented powder slurries of the invention depends in particular on the nature of the pigments and their functions. Where the process of the invention is used to prepare the pigmented powder coating materials of the invention, preference is given to employing the advantageous variant in which all, or the predominant fraction, of the pigments are/is present in and/or on the emulsified and suspended particles (D).

Examples of suitable pigments are known from German patent application DE 101 26 651 A1, page 14, para. [0137] to [0150].

When the above-described mixtures (A) for inventive use are used, pigment pastes or pigment preparations may have a particularly high nanoparticle content, which is a further valuable advantage of the mixtures (A) for inventive use.

In addition to the above-described pigments, or instead of them, the powder slurries and powder coating materials of the invention may comprise molecularly dispersed organic dyes. These molecularly dispersed dyes may be present either in the emulsified or suspended particles (D) or in the continuous phase, i.e., the aqueous medium (C). Alternatively, they may be present in the particles (D) or in the continuous phase (C). In this case, the fraction that is present in the particles (D) may comprise the majority, i.e., more than 50%, of the organic dyes used. However, less than 50% may be present, alternatively, in the particles (D). The distribution of the organic dyes between the phases may correspond to the thermodynamic equilibrium resulting from the solubility of the organic dyes in the phases. However, the distribution may also be far removed from the thermodynamic equilibrium. Where the emulsified and suspended particles (D) are used to prepare the powder coating materials of the invention, the dyes are present only in the particles (D).

Suitable organic dyes are all those soluble in the sense outlined above in the powder slurries and powder coating materials of the invention. Lightfast organic dyes are highly suitable. Lightfast organic dyes having little or no tendency to migrate from the coatings, adhesive layers, and seals produced from the powder slurries and powder coating materials of the invention are especially suitable. The migration tendency may be estimated by the skilled worker on the basis of his or her general knowledge of the art and/or determined with the aid of simple preliminary rangefinding tests, as part of tinting tests, for example.

The amount of the molecularly dispersed organic dyes in the powder slurries and powder coating materials of the invention may vary extremely widely and is guided primarily by the color and by the shade that is to be established, and also by the amount of any pigments present.

The powder slurries and powder coating materials of the invention may comprise additives.

Preferably, the additives, which may be present in both the pigmented and the unpigmented powder slurries and powder coating materials, are selected from the group consisting of UV absorbers, antioxidants, light stabilizers, free-radical scavengers, devolatilizers, additional, non-(A) emulsifiers, wetting agents, slip additives, polymerization inhibitors, crosslinking catalysts, thermolabile free-radical initiators, photoinitiators, thermally curable reactive diluents, reactive diluents curable with actinic radiation, adhesion promoters, flow control agents, rheology-control additives other than the thickeners (E), film-forming auxiliaries, flame retardants, corrosion inhibitors, free-flow aids, waxes, siccatives, biocides and/or matting agents.

Examples of suitable additives are known from German patent application DE 101 26 651 A1, page 16, para. [0156], to page 17, para. [0172].

For the process of the invention, the additives described above may be used either in the aqueous media (C) described above or in the melts (B) described above. The governing factor above all is whether they are to be present more effectively, depending on their customary and known functions, in the emulsified or suspended particles (D) or in the continuous, i.e., aqueous, phase (C). For example, it is of advantage for the powder slurries of the invention if the additional thickeners and emulsifiers are in the aqueous medium (C), i.e., substantially outside of the particles (D). Where the process of the invention is used for preparing the powder coating materials of the invention, the additives are predominantly or entirely within the melts (B) and the emulsified and suspended particles (D) produced from them. The skilled worker is therefore able easily to determine the process variant that is optimum for the case in hand, on the basis of his or her general knowledge of the art, with or without the assistance of simple preliminary tests.

The copolymers (A) for inventive use are outstanding emulsifiers and may advantageously be supplied to all intended uses for which the use of emulsifiers is necessary. In particular, they are outstandingly suitable for the process of the invention.

The powder slurries of the invention possess outstanding stability and storability and have an outstanding application behavior. In particular they exhibit outstanding shear stability on ESTA application, and so can be applied without problems in existing painting plants for liquid coating materials.

The powder coating materials of the invention have outstanding fluidity, storability and transportability and do not exhibit any caking even on prolonged storage. The application behavior is outstanding.

The powder slurries and powder coating materials of the invention are outstandingly suitable as coating materials, adhesives, and sealing compounds, or for preparing such compositions.

The coating materials of the invention are outstandingly suitable for producing single-coat or multicoat, color and/or effect, electrically conductive, magnetically shielding or fluorescent coatings, such as primer-surfacer coats, basecoats, solid-color topcoats or combination effect coats, or single-coat or multicoat clearcoat systems.

The adhesives of the invention are outstandingly suitable for producing adhesive layers, and the sealing compounds of the invention are outstandingly suitable for producing seals.

Very particular advantages result when the unpigmented powder slurries and powder coating materials of the invention are used as clearcoat materials for producing single-coat or multicoat clearcoat systems. In particular, the clearcoat materials of the invention are used to produce multicoat color and/or effect paint systems by the wet-on-wet technique, in which a basecoat material, especially an aqueous basecoat material, is applied to the surface of a substrate and then the resulting basecoat film is dried, without being cured, and is overcoated with a clearcoat film. Thereafter, the two films are cured together.

Very particular advantages also result when the pigmented powder slurries and powder coating materials of the invention are used to produce single-coat or multicoat color and/or effect paint systems or combination effect coats. A combination effect coat is a coating which performs at least two functions in a color and/or effect paint system. Functions of this kind include in particular protection against corrosion, adhesion promotion, the absorption of mechanical energy, and the imparting of color and/or effect. Preferably, the combination effect coat serves to absorb mechanical energy and to impart color and/or effect at the same time; it therefore fulfills the functions of a primer-surfacer coat or antistonechip primer and of a basecoat. Preferably, the combination effect coat additionally has a corrosion protection effect and/or adhesion promotion effect.

The pigmented coatings or coating systems may likewise be produced using wet-on-wet techniques. For example, the pigmented powder slurries and powder coating materials of the invention may be applied to electrocoat films which have not cured, or not cured fully, and then the films one above the other are cured together.

The very particular advantage of the powder slurries and powder coating materials of the invention is that they can be used to produce multicoat paint systems of all kinds based entirely or predominantly on the powder slurries and/or powder coating materials of the invention.

In terms of its method, the application of the powder slurries of the invention has no special features but may take place by any customary application method, such as spraying, knife coating, brushing, flow coating, dipping, trickling or rolling, for example. It is preferred to employ spray application methods, such as compressed air spraying, airless spraying, high-speed rotation, electrostatic spray application (ESTA), alone or in conjunction with hot spray application such as hot air spraying, for example. In particular, ESTA with high-speed rotating bells is used. Here again, it is advisable to work in the absence of actinic radiation in order to prevent premature crosslinking of the dual-cure coating materials, adhesives, and sealing compounds of the invention.

The application of the powder coating materials also has no special features in terms of its method but instead takes place, for example, in accordance with the customary and known fluid-bed coating techniques, as known, for example, from the BASF Coatings AG brochures “Pulverlacke für Industrielle Anwendungen” [Powder coatings for industrial applications], January 2000, or “Coatings Partner, Pulverlack Spezia!” [Coatings partner, powder coatings special], 1/2000, or Römpp Lexikon Lacke and Druckfarben, Georg Thieme Verlag, Stuttgart, New York, 1998, pages 187 and 188, “electrostatic powder spraying”, “electrostatic spraying”, and “electrostatic fluidized-bath process”.

Suitable substrates are all those whose surface and substance are not damaged by the application of heat and/or actinic radiation in the course of the curing of the films present thereon. Preferably, the substrates comprise metals, plastics, wood, ceramic, stone, textile, fiber composites, leather, glass, glass fibers, glass wool and rockwool, mineral- and resin-bound building materials, such as plasterboard and cement slabs or roof shingles, and also composites of these materials.

Accordingly, the coating materials, adhesives, and sealing compounds of the invention are outstandingly suitable for coating, adhesive bonding, and sealing
means of land, water or air transport which are operated by muscle power, hot air or wind, such as cycles, railroad trollies, rowboats, sailboats, hot air balloons, gas balloons or sailplanes, and also parts thereof,
motorized means of land, water or air transport, such as motorcycles, utility vehicles or motor vehicles, especially automobiles, watergoing or underwater craft or aircraft, and also parts thereof,
stationary floating structures, such as buoys or parts of harbor installations,
the interior and exterior of buildings,
doors, windows, and furniture, and
hollow glassware,
and also, in the context of industrial coating, for the coating, adhesive bonding, and sealing of
small parts, such as nuts, bolts, hubcaps or wheel rims,
containers, such as coils, freight containers or packaging,
electrical components, such as motor windings or transformer windings,
optical components,
mechanical components, and
white goods, such as household appliances, boilers, and radiators.

In particular they are suitable for the coating of motor vehicle bodies, especially top-class automobile bodies.

In the case of electrically conductive substrates it is possible to use primers produced conventionally from electrodeposition coating (electrocoat) materials. Both anodic and cathodic electrocoat materials are suitable for this purpose, but especially cathodic electrocoat materials. Unfunctionalized and/or nonpolar plastics surfaces may be subjected prior to coating in a known manner to a pretreatment, such as with a plasma or by flaming, or may be provided with a water-based primer.

The curing of the applied powder slurries and powder coating materials of the invention also has no special features in terms of its method but instead takes place in accordance with the customary and known thermal methods, such as heating in a forced-air oven or irradiation using IR lamps. For actinic radiation curing, suitable radiation sources include those such as high- or low-pressure mercury vapor lamps, which may be doped with lead in order to open up a radiation window up to 405 nm, or electron beam sources. Further examples of suitable techniques and apparatus for curing with actinic radiation are described in German patent application DE 198 18 735 A1, column 10 lines 31 to 61, German patent application DE 103 16 890 A1, page 17 paras. [0128] to [0130], or international patent application WO 94/11123, page 2 line 35 to page 3 line 6, page 3 lines 10 to 15, and page 8 lines 1 to 14.

The resultant coatings of the invention, especially the single-coat or multicoat color and/or effect paint systems, combination effect coats, and clearcoats of the invention, are easy to produce and have outstanding optical properties and very high light stability, chemical, water, condensation, and weathering resistance. In particular they are free from turbidities and inhomogeneities. They are hard, flexible, and scratch-resistant. They exhibit very good reflow and outstanding intercoat adhesion, and exhibit good to very good adhesion to customary and known automotive refinishes. Especially, though, they are superior in gloss, haze, and leveling to the prior art coatings.

The adhesive layers of the invention bond a very wide variety of substrates to one another firmly and durably and possess high chemical and mechanical stability even under extreme temperatures and/or temperature fluctuations.

Similarly, the seals of the invention seal the substrates durably and possess high chemical and mechanical stability even under extreme temperatures and/or temperature fluctuations and even in conjunction with exposure to aggressive chemicals.

A further advantage of the dual-cure coating materials, adhesives and sealing compound of the invention is that, even in the shadow zones of three-dimensional substrates of complex shape, such as vehicle bodies, radiators or electrical wound goods, and even without optimum—especially complete—illumination of the shadow zones with actinic radiation, they produce coatings, adhesive layers, and seals whose profile of performance properties is at least equal to that of the coatings, adhesive layers, and seals outside the shadow zones. As a result, the coatings, adhesive layers and seals of the invention in the shadow zones are also no longer readily damaged by mechanical and/or chemical attack, as may occur, for example, when further components of motor vehicles are installed in the coated bodies.

Accordingly, the primed or unprimed substrates which are commonly employed in the technological fields set out above and which are coated with at least one coating of the invention, bonded with at least one adhesive layer of the invention and/or sealed with at least one seal of the invention combine a particularly advantageous profile of performance properties with a particularly long service life, so making them particularly attractive economically.

### EXAMPLES

### Preparation Example 1

### The Preparation of Emulsifier (A1)

A suitable reaction vessel fitted with three feed vessels, stirrer, reflux condenser, and oil heating was charged with 1839.5 parts by weight of deionized water and this initial charge was heated to 90° C. Thereafter, at this temperature, three separate feed streams were metered into the initial charge in parallel and at a uniform rate. The first feed stream consisted of 403.5 parts by weight of methyl methacrylate, 178.2 parts by weight of acrylic acid, 13.4 parts by weight of isobutyl methacrylate, 224.7 parts by weight of n-butyl methacrylate, 165.4 parts by weight of hydroxyethyl methacrylate and 65.7 parts by weight of 1,1-diphenylethylene. The second feed stream consisted of 173.5 parts by weight of a 25% strength by weight ammonia solution in water. The third feed stream consisted of a solution of 78.9 parts by weight of ammonium peroxodisulfate in 183.8 parts by weight of deionized water. The first and second feed streams were metered into the initial charge at a uniform rate over the course of 4 hours. The third feed stream was metered in at a uniform rate over the course of 4.5 hours. After the end of the addition, polymerization was continued for 3 hours. During this time the temperature of the reaction mixture was slowly reduced to 40° C. The resulting dispersion of emulsifier (A1) had a solids content of 34.3% by weight (1 hour/130° C.), a pH of 5.3, a calculated acid number of 132 mg KOH/g resin solids, a calculated hydroxyl number of 68 mg KOH/g resin solids, and a surface tension of 40.7 mN/m.

### Preparation Example 2

### The preparation of Emulsifier (A2)

Preparation example 1 was repeated with the difference that 65.7 parts by weight of 1,1-diphenylethylene were replaced by using 65.7 parts by weight of gamma-terpinene. The resulting dispersion of emulsifier (A2) had a solids content of 34.5% by weight (1 hour/130° C.), a surface tension of 36.2 mN/nm, a calculated acid number of 132 mg KOH/g resin solids, and a calculated hydroxyl number of 68 mg KOH/g resin solids.

### Preparation Example 3

### The Preparation of a Hydroxy-Functional Methacrylate Copolymer (Binder)

A suitable reaction vessel was charged with 42.15 parts by weight of methyl ethyl ketone and this initial charge was heated to 78° C. Added thereto at 78° C. over 6 hours and 45 minutes, via two separate feed streams, was, firstly, an initiator solution of 5.1 parts by weight of tert-butyl perethylhexanoate and 2.75 parts by weight of methyl ethyl ketone and, secondly, over 4 hours, 50 parts by weight of a monomer mixture of 55% by weight of n-butyl methacrylate, 40.5% by weight of hydroxyethyl methacrylate, 3.3% by weight of isobutyl methacrylate and 1.2% by weight of methacrylic acid, metered in at a uniform rate with stirring. The addition of the monomer mixture was commenced 15 minutes after the beginning of the addition of the initiator solution. The resulting reaction mixture was heated gradually to 150° C. and the solvent was distilled off completely at 20 mbar. The resulting hot melt of the binder was drained from the reaction vessel. Cooling to room temperature gave a colorless solid.

### Example 1

### The preparation of Powder Slurry 1

A first container was charged with a mixture (B1) composed, based in each case on (B1), of 95.33% by weight of the binder from preparation example 3 and 4.67% by weight of 2,5-diethyloctane-1,5-diol. The contents of the container were heated to 150° C.

A second container was charged with a mixture (B2) composed, based in each case on (B2), of 94.18% by weight of a commercial, 3,5-dimethylpyrazole-blocked polyisocyanate based on hexamethylene diisocyanate, 1.02% by weight of a light stabilizer (HALS, Tinuvin® 123 from Ciba Specialty Chemicals) and 4.8% by weight of a UV stabilizer (triazine, Tinuvin® 400 from Ciba Specialty Chemicals). The contents of the container were heated to 110° C.

At the set temperatures there resulted melts (B1) and (B2) whose viscosity permitted further processing, in particular conveying.

Before the melts (B1) and (B2) were conveyed through the unit using a toothed-ring dispersing unit (“K-Generator” from Kinematica AG, Lucerne, Switzerland), the entire unit was heated to 100° C. with steam. Thereafter the two melts (B1) and (B2) were metered into a static Sulzer mixer by way of separate, heated lines using volumetric pumps. Using the volume flow of the pumps, a stoichiometric ratio of blocked isocyanate groups to hydroxyl groups was set. Within the static mixer, the two melts (B1) and (B2) were subjected to molecularly disperse mixing within a very short time (approximately six seconds). The resulting homogeneous melt (B), which was still at a temperature above the melting point of the constituents, was conveyed into the preliminary emulsifying zone of the toothed-ring dispersing unit via an injector pipe.

Metered into the preliminary emulsifying zone was an aqueous medium (C) composed, based in each case on (C), of 97.74% by weight of deionized water, 0.61% by weight of the emulsifier dispersion (A1) from preparation example 1, 0.68% by weight of dimethylethanolamine and 0.97% by weight of a commercial nonionic surfactant (Lutensol® AT50 from BASF Aktiengesellschaft), using a volumetric pump. The aqueous medium (C) had been heated to the process temperature before being metered, in a pressure-resistant container.

Energy input with a first rotor/stator system of the toothed-ring dispersing unit was used to produce an initial emulsion in which the aqueous medium (C) formed the continuous phase. The initial emulsion was comminuted to an average particle size of between 1 and 4 μm in a further zone of the toothed-ring dispersing unit. The energy input of the rotor/stator system was set via the width of the working gap between rotor and stator, by the geometry of the teeth of the respective rotor and stator, and by the rotary speed. The rotary speed of the toothed-ring dispersing unit in the present case was 12 000 rpm; the residence time was approximately six seconds.

The process was carried out such that the resulting emulsion was composed, based in each case on the emulsion, of 59% by weight of the aqueous medium (C), 21.4% by weight of the melt (B1) and 19.6% by weight of the melt (B2).

Following dispersion, the emulsion was cooled rapidly to temperatures <40° C. in a downstream heat exchanger. The resulting powder slurry 1 had a solids content of 38.5% by weight, determined in a forced-air oven at 125° C. over one hour.

Powder slurry 1 was stable to sedimentation. It had outstanding transport and storage properties. These advantages, surprisingly, were achievable with just a comparatively small amount of emulsifier.

For the purpose of application the slurry was filtered via a cascade composed of a filter bag (mesh size 25 μm) and a MicroKlean® cartridge (cutoff limit 3 μm). Its application by electrostatic spraying (ESTA) did not give rise to any problems.

### Example 2

### The Preparation of Powder Slurry 2

To prepare powder slurry 2, example 1 was repeated with the difference that the emulsifier (A2) of preparation example 2 was used rather than the emulsifier (A1) of preparation example 1. The same advantageous results were obtained.

### Examples 3 and 4

### The Production of Multi Coat Paint Systems 1 and 2

Multicoat paint system 1 of example 3 was produced using powder slurry 1 of example 1.

Multicoat paint system 2 of example 4 was produced using powder slurry 2 of example 2.

To produce the multicoat paint systems 1 and 2, test panels measuring 10 cm×20 cm were produced conventionally. For this purpose, steel panels (vehicle bodywork panels) which had been coated with customary and known cathodic electrodeposition coats, and baked, were coated with a commercial low-build primer-surfacer (Ecoprime® from BASF Coatings AG), after which the resulting primer-surfacer films were flashed off at 20° C. and a relative atmospheric humidity of 65% for five minutes and dried at 80° C. in a forced-air oven for five minutes. Thereafter the primer-surfacer coats had a dry film thickness of 15 μm.

After the test panels had been cooled to 20° C., two-coat aqueous basecoat films were applied, produced from the commercially available BASF Coatings AG aqueous basecoat materials Metrograu (gray aqueous basecoat film 1) and Atollblau (blue aqueous basecoat film 2), which were flashed off at 23° C. for 5 minutes and at 40° C. for 10 minutes, with a relative atmospheric humidity of 65%, and then dried in a forced-air oven at 80° C. for 7 minutes so that the dried basecoats had a dry film thickness of approximately 15 μm.

After the test panels had again been cooled to 20° C., the basecoats were overcoated with the powder slurries 1 or 2 of the invention. In the case of example 3, powder slurry 1 was thus applied by ESTA. In the case of example 4, powder slurry 2 was applied pneumatically.

The resulting powder slurry clearcoat films 1 and 2 were flashed off at 20° C. for 3 minutes and a relative atmospheric humidity of 65% and then dried in a forced-air oven at 60° C. for 5 minutes.

Following the application of all the films, they were baked together at 150° C. for 30 minutes, to give multicoat paint systems 1 and 2. Their clearcoats 1 and 2 had a film thickness of 40 μm.

Multicoat paint systems 1 and 2 were highly glossy and exhibited very good leveling. Gloss and haze were measured in accordance with DIN 67530.

The leveling or waviness was measured by the wavescan method. For this purpose a laser beam was directed onto the surfaces at an angle of 60°, and over a measuring distance of 10 cm the fluctuations of the reflected light were recorded in the longwave region (0.6 to 10 mm; observation distance: 2.5 m) and in the shortwave region (0.1 to 0.6 mm; observation distance: 45 cm) using a measuring instrument.

The results are found in table 1.

TABLE 1
Gloss and leveling of multicoat paint systems 1 and 2

Multicoat paint system

| | 1 | 2 |
|---|---|---|
| Gloss (20°) | 87 | 86 |
| Haze | 17 | 26 |
| Leveling (longwave/shortwave) | 16/25 | 11/50 |

The results underline the fact that multicoat paint systems 1 and 2 exhibited very good gloss, low haze, and very good leveling.

Moreover, multicoat paint systems 1 and 2 were flexible, hard, and scratch-resistant and had outstanding solvent resistance (more than 100 double rubs in the methyl ethyl ketone test without damage) and good condensation resistance. The intercoat adhesion was very good.

1. A powder coating suspension prepared in the presence of an emulsifier (A), by a process comprising:
emulsifying a liquid component (B) comprising a liquid or liquefied constituent of a powder slurry or of a powder coating material in an aqueous medium (C) to give an aqueous emulsion of liquid particles (D); and
cooling the emulsion of liquid particles (D) to give the powder coating suspension, which comprises a suspension of dimensionally stable particles (D);
wherein the emulsifier (A) has a hydroxyl number of 50 to 250 mg KOH/g and is a copolymers prepared by single-stage or multistage free-radical copolymerization, in an aqueous medium, of
(a1) a hydroxyl-containing, olefinically unsaturated monomer; and
(a2) an olefinically unsaturated monomer different from the hydroxyl-containing, olefinically unsaturated monomer (a1) and selected from the group consisting of:
(a21) a monomers of the general formula I:
R¹R²C═CR³R⁴ (I),
wherein R¹, R², R³, and R⁴ are independently hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of R¹, R², R³, and R⁴ are substituted or unsubstituted aryl, arylalkyl or arylcycloalkyl radicals;
(a22) an olefinically unsaturated terpene hydrocarbons; and
(a23) a dimeric alpha-alkylvinylaromatic.

2. The powder coating suspension of claim 1, wherein the emulsifier (A) is used in an amount such that the aqueous emulsions of the liquid particles (D), based in each case on their solids content, contain from 0.01 to 1% by weight of (A).

3. The powder coating suspension claim 1, wherein the hydroxyl-containing, olefinically unsaturated monomers (a1) is selected from the group consisting of hydroxyalkyl esters of acrylic acid, hydroxyalkyl esters methacrylic acid, hydroxyalkyl esters ethacrylic acid, hydroxyalkyl esters crotonic acid, hydroxyalkyl esters maleic acid, hydroxyalkyl esters fumaric acid, hydroxyalkyl esters itaconic acid, hydroxycycloalkyl esters of acrylic acid, hydroxycycloalkyl esters of methacrylic acid, hydroxycycloalkyl esters of ethacrylic acid, hydroxycycloalkyl esters of crotonic acid, hydroxycycloalkyl esters of maleic acid, hydroxycycloalkyl esters of fumaric acid, hydroxycycloalkyl esters of itaconic acid, and reaction products of cyclic esters with these foregoing hydroxyalkyl esters, reaction products of cyclic esters with the foregoing and hydroxycycloalkyl esters, olefinically unsaturated alcohols, and combinations thereof.

4. The powder coating suspension of claim 3, wherein the hydroxyl-containing, olefinically unsaturated monomers (a1) is selected from the group consisting of 2-hydroxyethyl acrylate, 2-hydroxypropyl acrylate, 3-hydroxypropyl acrylate, 3-hydroxybutyl acrylate, 4-hydroxybutyl acrylate, 2-hydroxyethyl methacrylate, 2-hydroxypropyl methacrylate, 3-hydroxypropyl methacrylate, 3-hydroxybutyl methacrylate, 4-hydroxybutyl methacrylate, 2-hydroxyethyl ethacrylate, 2-hydroxypropyl ethacrylate, 3-hydroxypropyl ethacrylate, 3-hydroxybutyl ethacrylate, 4-hydroxybutyl ethacrylate, 2-hydroxyethyl crotonate, 2-hydroxypropyl crotonate, 3-hydroxypropyl crotonate, 3-hydroxybutyl crotonate, 4-hydroxybutyl crotonate, 2-hydroxyethyl maleate, 2-hydroxypropyl maleate, 3-hydroxypropyl maleate, 3-hydroxybutyl maleate, 4-hydroxybutyl maleate, 2-hydroxyethyl fumarate, 2-hydroxypropyl fumarate, 3-hydroxypropyl fumarate, 3-hydroxybutyl fumarate, 4-hydroxybutyl fumarate, 2 hydroxyethyl itaconate, 2-hydroxypropyl itaconate, 3-hydroxypropyl itaconate, 3-hydroxybutyl itaconate, 4-hydroxybutyl itaconate; 1,4-bis(hydroxymethyl)cyclohexane monoacrylate, octahydro-4,7-methano-1H-indenedimethanol monoacrylate, methylpropanediol monoacrylate, 1,4-bis(hydroxymethyl)cyclohexane monomethacrylate, octahydro-4,7-methano-1H-indenedimethanol monomethacrylate, methylpropanediol monomethacrylate, 1,4-bis(hydroxymethyl)cyclohexane monoethacrylate, octahydro-4,7-methano-1H-indenedimethanol monoethacrylate, methylpropanediol monoethacrylate, 1,4-bis(hydroxymethyl)cyclohexane monocrotonate, octahydro-4,7-methano-1H-indenedimethanol monocrotonate, methylpropanediol monocrotonate, 1,4-bis(hydroxymethyl)cyclohexane monomaleate, octahydro-4,7-methano-1H-indenedimethanol monomaleate, methylpropanediol monomaleate, 1,4-bis(hydroxymethyl)cyclohexane mono fumarate, octahydro-4,7-methano-1H-indenedimethanol mono fumarate, methylpropanediol mono fumarate, 1,4-bis(hydroxymethyl)cyclo hexane monoitaconate, octahydro-4,7-methano-1H-indenedimethanol monoitaconate, methylpropanediol monoitaconate; reaction products of epsilon-caprolactone with the foregoing; allyl alcohol, trimethylolpropane monoallyl ether, trimethylolpropane diallyl ether, pentaerythritol monoallyl ether, pentaerythritol diallyl ether, pentaerythritol triallyl ether, and combinations thereof.

5. The powder coating suspension claim 1, wherein at least two of R¹, R², R³, and/or R⁴, or a combination thereof, are independently phenyl or naphthyl radicals.

6. The powder coating suspension of claim 1, wherein at least two of R¹, R², R³, and R⁴ are phenyl radicals.

7. The powder coating suspension of claim 1, wherein the substituted R¹, R², R³ or R⁴ comprise substituents selected from the group consisting of electron-withdrawing atoms, electron-donating atoms, electron-withdrawing organic radicals, electron-donating organic radicals, and combinations thereof.

8. The powder coating suspension of claim 7, wherein the substituents are selected from the group consisting of halogen atoms, nitrile radicals, nitro radicals, partly halogenated alkyl radicals, fully halogenated alkyl radicals, cycloalkyl radicals, alkylcycloalkyl radicals, cycloalkylalkyl radicals, aryl radicals, alkylaryl radicals, cycloalkylaryl radicals, arylalkyl radicals, and arylcycloalkyl radicals; aryloxy radicals, alkyloxy radicals, cycloalkyloxy radicals radicals; arylthio radicals, alkylthio radicals, cycloalkylthio radicals; primary amino groups, secondary amino groups, tertiary amino groups, and combinations thereof.

9. The powder coating suspension of claim 1, wherein the olefinically unsaturated terpene hydrocarbon (a22) is selected from the group consisting of acyclic diterpenes, monocyclic terpenes, bicyclic terpenes, acyclic sesquiterpenes, monocyclic sesquiterpenes, bicyclic sesquiterpenes, tricyclic sesquiterpenes, acyclic diterpenes, monocyclic diterpenes, tricyclic diterpenes, and combinations thereof.

10. The powder coating suspension of claim 1, wherein the olefinically unsaturated terpene hydrocarbon (a22) is selected from the group consisting of acyclic monoterpenes, monocyclic terpenes, bicyclic terpenes, and combinations thereof.

11. The powder coating suspensions of claim 1, wherein the olefinically unsaturated terpene hydrocarbon (a22) is selected from the group consisting of ocimene, myrcene, the menthenes, the menthadienes, alpha-pinene, beta-pinene, and combinations thereof.

12. The powder coating suspension of claim 11, wherein the menthadienes are selected from the group consisting of alpha-terpinene, beta-terpinene, gamma-terpinene, terpinolene, alpha-phellandrene, beta-phellandrene, limonene, dipentene, and combinations thereof.

13. The powder coating suspension of claim 12, wherein the menthadienes are selected from gamma-terpinene.

14. The powder coating suspension of claim 1, wherein the dimeric alpha-alkylvinylaromatic (a23) is a dimeric alpha-alkylstyrene.

15. The powder coating suspension of claim 14, wherein the dimeric alpha-alkylstyrene is a dimeric alpha-methylstyrene.

16. The powder coating suspension of claim 1, wherein the hydroxyl-containing, olefinically unsaturated monomers (a1) and the olefinically unsaturated monomer (a2) are copolymerized with at least one different olefinically unsaturated monomer (a3).

17. The powder coating suspension of claim 16, wherein the olefinically unsaturated monomers (a3) is selected from the group of olefinically unsaturated monomers (a33) containing acid groups.

18. The powder coating suspension of claim 17, wherein the olefinically unsaturated monomers (a33) containing acid groups are selected from the group consisting of acrylic acid, beta-carboxyethyl acrylate, methacrylic acid, ethacrylic acid, crotonic acid, maleic acid, fumaric acid, itaconic acid; olefinically unsaturated sulfonic acid, partial esters of olefinically unsaturated sulfonic acid, olefinically unsaturated phosphonic acids, partial esters of olefinically unsaturated phosphonic acid; mono (meth)acryloyloxyethyl maleate, mono(meth)acryloyloxyethyl succinate, mono(meth)acryloyloxyethyl phthalate, and combinations thereof.

19. The powder coating suspension of claim 17, wherein the emulsifiers (A) has an acid number of 100 to 400 mg KOH/g.

20. The powder coating suspension of claim 1, wherein the emulsifier (A) is present in the aqueous medium (C).

21. A process for preparing a powder coating suspension comprising:
emulsifying a liquid component (B) comprising a liquid or liquefied constituent of a powder slurry or of a powder coating material in an aqueous medium (C) in the presence of an emulsifier (A) to give an aqueous emulsion of liquid particles (D); and
cooling the emulsion of liquid particles (D) to give the powder coating suspension, which comprises a suspension of dimensionally stable particles (D);
wherein the emulsifier (A) has a hydroxyl number of 50 to 250 mg KOH/g and is a copolymer prepared by single-stage or multistage free-radical copolymerization, in an aqueous medium, of (a1) a hydroxyl-containing, olefinically unsaturated monomer; and (a2) an olefinically unsaturated monomer different from the hydroxyl-containing, olefinically unsaturated monomer (a1) and selected from the group consisting of:
(a21) a monomer of the general formula I:
R¹R²C═CR³R⁴ (I),
wherein R¹, R², R³, and R⁴ are independently hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of R¹, R², R³, and R⁴ are substituted or unsubstituted aryl, arylalkyl or arylcycloalkyl radicals;
(a22) an olefinically unsaturated terpene hydrocarbon; and
(a23) a dimeric alpha-alkylvinylaromatic.

22. The process of claim 21, wherein the aqueous medium (C) comprises the emulsifier (A) in an amount, based on (C), of 0.01 to 5% by weight.

23. The process of claim 21, wherein emulsifying the liquid component (B) is at a temperature of 100 to 150° C.

24-31. (canceled)

32. A process for preparing a powder coating material, comprising the process of claim 21, and further comprising isolating the dimensionally stable particles (D).

33. A powder coating material comprising the powder coating suspension of claim 1, wherein the process further comprises isolating the dimensionally stable particles (D).
